(19) United States
(12) Patent Application Publication
(10) Pub. No.: US 2005/0200690 A1
(43) Pub. Date: Sep. 15, 2005

(54) Thermal printer

(76) Inventor: Hiroyuki Matsukawa, Saitama (JP)

Correspondence Address: SUGHRUE MION, PLLC, 2100 PENNSYLVANIA AVENUE, N.W., SUITE 800, WASHINGTON, DC, 20037, US

(21) Appl. No.: 11/079,228

(22) Filed: Mar. 15, 2005

(30) Foreign Application Priority Data
Mar. 15, 2004 (JP) 2004-073366

(51) Int. Cl. B41J 2/315; B41J 2/32; G01D 15/10; B41J 2/325; B41J 15/10; B41J 29/16

(52) U.S. Cl. 347/179

(57) ABSTRACT

A transport path for transporting a recording paper or a cleaning sheet shifts between a recording position and a cleaning position. In the recording position, heating elements press against the recording paper, while a substrate does not come in contact with the recording paper. In the cleaning position, the cleaning sheet comes in contact with a heating element array and a part of the substrate at the downstream side of the heating element array. The cleaning sheet rubs stains off the heating element array and the downstream area when transported.

### BACKGROUND OF THE INVENTION

1. Field of the Invention

The present invention relates to a thermal printer capable of cleaning a thermal head with a cleaning sheet.

2. Background Arts

A thermal printer is known to record images with a thermal head. There are two types of the thermal printer: a direct thermal printer for recording images by developing colors on a thermal recording paper and a thermal wax transfer printer for recording images by transferring ink of an ink ribbon to a recording paper. In the thermal printer, the thermal recording paper (hereinafter referred to as the recording paper) is nipped between the thermal head and a platen roller. The thermal printer records images on the recording paper by heating the recording paper with the thermal head while transporting the recording paper at a constant speed.

The thermal head has a substrate with a heating element array of a plurality of heating elements disposed in alignment thereon. The heating element array comprises a linear partial glaze, which is approximately semicircle in section, and heating elements formed along the top of the partial glaze. In an image recording, each heating element is heated to a high temperature while pressed against the recording paper. A protective layer on the surface of the recording paper is softened by the heat of the heating element array and then comes off to stain the heating element array and its surrounding area on the substrate, particularly in the downstream side of it.

Because the stains on the thermal head deteriorate the image quality, a cleaning operation is performed to the thermal head. For example, a cleaning sheet whose surface is coated with abrasive is used to clean the thermal head, as disclosed in Japanese Patent Laid-Open Publication Number H5-138992. The cleaning sheet instead of the recording paper is transported in a transport path in the thermal printer to rub the stain off the heating element array.

However, this cleaning method presses the cleaning sheet against the heating element array only in the same way as in the image recording. The cleaning sheet therefore rubs off the stains only from the heating element array but not from the surrounding areas of it.

### SUMMARY OF THE INVENTION

An object of the present invention is to provide a thermal printer that certainly prevents deterioration in the quality of images by removing stains on the thermal head with a cleaning sheet.

The above object and other objects are achieved by shifting a transport path from a recording position to a cleaning position in a cleaning operation of the thermal head. The thermal head has a heating element array formed on a substrate and nips a recording paper between the heating element array and a platen roller. The heating element array records images on the recording paper pressing against it. In the recording position the heating element array presses against the recording paper, whereas the substrate does not come in contact with the recording paper. In the cleaning position the cleaning sheet comes in contact with a part of the substrate at the downstream side of the heating element array as well as the heating element array and rubs the stain off both of them.

In a preferable embodiment of the present invention, the transport path is shifted to the cleaning position by a shift of a transport roller pair. The platen roller is shifted toward the transport roller pair in another embodiment of the present invention. In still another embodiment of the present invention, a tilt angle of the thermal head is increased from it in recording. The front side of the thermal head is swingable about the rear side of the substrate and provided with the heating element array.

According to the thermal printer of the present invention, it can prevent deterioration in the quality of images caused by the stains on the thermal head by removing them not only from the heating elements but also from the surrounding area of the heating elements, with which the recording paper under transportation does not come in contact.

### BRIEF DESCRIPTION OF THE DRAWINGS

One with ordinary skill in the art would easily understand the above-described objects and advantages of the present invention when the following detailed description is read with reference to the drawings attached hereto.

FIG. 1 is a schematic side view illustrating a constitution of a color thermal printer of the present invention;

FIG. 2 is a perspective view illustrating stains on a thermal head;

FIG. 3 is an explanatory view illustrating a shift of a transport path by transportation rollers;

FIG. 4 is an explanatory view illustrating the shift of the transport path by a platen roller; and

FIG. 5 is an explanatory view illustrating the shift of the transport path by the thermal head.

### PREFERRED EMBODIMENTS OF THE INVENTION

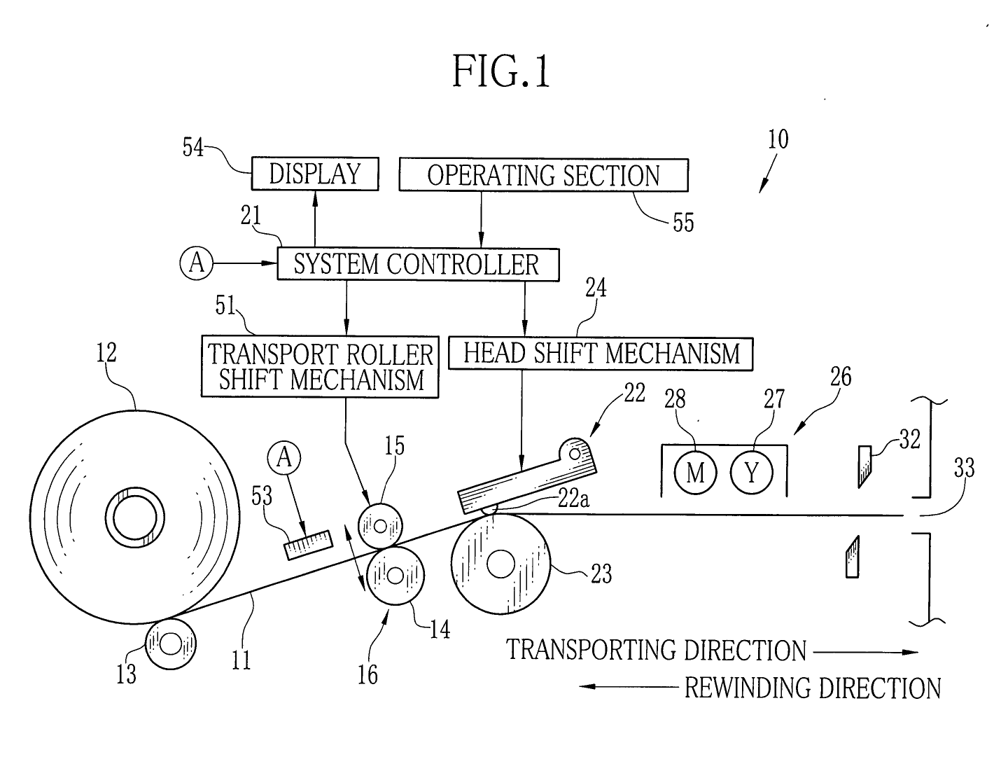

As shown in FIG. 1, a recording paper roll 12, in which a continuous recording paper 11 is rolled up, is loaded in a color thermal printer 10. A cyan thermosensitive coloring layer, a magenta thermosensitive coloring layer, and a yellow thermosensitive coloring layer are stacked on a support in the stated order to form the recording paper 11. The yellow thermosensitive coloring layer, formed on top of the other two thermosensitive coloring layers, has the highest thermosensitivity among the three thermosensitive coloring layers and develops the yellow color with low thermal energy. The cyan thermosensitive coloring layer, formed under the other two thermosensitive coloring layers, has the lowest thermosensitivity among the three thermosensitive coloring layers and needs high thermal energy to develop the cyan color. The yellow thermosensitive coloring layer loses its ability to develop the yellow color when exposed to yellow-fixing light, ultraviolet rays of blue-violet color having the emission wavelength peak at 420 nm. The magenta thermosensitive coloring layer develops the magenta color by a thermal energy level between the one to the yellow thermosensitive coloring layer and the other to the cyan thermosensitive coloring layer. The magenta thermal coloring layer loses its ability to develop the magenta color when exposed to magenta-fixing light, near ultraviolet rays having the emission wavelength peak at 365 nm.

A feed roller 13 draws the front end of the recording paper 11 out of the recording paper roll 12 to a transport path by coming in contact with the recording paper roll 12 and rotating it. A transport roller pair 16, comprising a capstan roller 14 and a pinch roller 15, is disposed at the downstream side of the feed roller 13. The transport roller pair 16 transports the recording paper 11 in a transporting direction and a rewinding direction shown by the arrows while nipping the recording paper 11. The transport path comprises a guide mechanism (not shown) for guiding the recording paper 11. The guide mechanism is formed by two plates disposed one above the other or a pair of channel members disposed on either side of the transportation course.

The feed roller 13 and the transport roller pair 16 are rotated both clockwise and counterclockwise by a transport motor (not shown). The transport motor is controlled by a system controller 21 that controls the whole of the color thermal printer 10. A thermal head 22 is disposed at the downstream side of the transport roller pair 16. The thermal head 22 is provided with a heating element array 22a having a plurality of heating elements aligned in a main scanning direction, and provides thermal energy to a recording face (the side the thermosensitive coloring layers are formed on) of the recording paper 11 in accordance with the gradation of the image data by heating each heating element while pressing the heating element array 22a against the recording paper 11. The thermal head 22 is driven by a head driver based on the image data sent from the system controller 21.

A platen roller 23 is disposed in a position opposite to the heating element array 22a to support the recording paper 11 from its rear side (the reverse side of the recording face). The platen roller 23 secures the contact of the recording paper 11 and the heating element array 22a while being rotated by the recording paper 11 under transportation. The recording paper 11 is pressed against the heating element array 22a by being nipped between the thermal head 22 and the platen roller 23. The thermal head 22 thermally records images, while the recording paper 11 is transported in the rewinding direction, after the recording area of the recording paper 11 is transported past the thermal head 22.

The head shift mechanism 24 swings the thermal head 22 between a retreated position for providing a space between the heating element array 22a and the platen roller 23 and a pressing position for pressing the heating element array 22a against the recording paper 11. In feeding the recording paper 11 to the transport path, the thermal head 22 is in the retreated position to provide a passage for the recording paper between the heating element array 22a and the platen roller 23. In recording, the thermal head 22 shifts to the pressing position to press the heating element array 22a against the recording paper 11.

An optical fixer 26 is disposed at the downstream side of the thermal head 22. The optical fixer 26 is provided with a yellow-fixing lamp 27 and a magenta-fixing lamp 28 for emitting the yellow-fixing light and the magenta-fixing light respectively. After thermally recorded, a yellow image is optically fixed by the yellow-fixing lamp 27 that is then lit up, while the recording paper 11 is transported in the transporting direction. Next, the yellow-fixing lamp 27 is turned off and a magenta image is thermally recorded, while the recording paper 11 is transported in the rewinding direction. After thermally recorded, the magenta image is optically fixed by the magenta-fixing lamp 28 that is then lit up, while the recording paper 11 is transported in the transporting direction. After passing the optical fixer 26, the recording area is moved back in the rewinding direction and a cyan image is recorded thereon. A cutter 32 is disposed at the downstream side of the optical fixer 26 for cutting the recording area carrying the full-color image into a sheet. The sheet cut by the cutter 32 is ejected out of the printer via a discharge opening 33. The remaining unrecorded recording paper 11 is rewound in the recording paper roll 12.

In a cleaning process, a cleaning sheet 40 instead of the recording paper 11 is fed to the color thermal printer 10. The cleaning sheet 40 is a paper or a resin film having a surface coated with abrasive or plastic layer containing abrasive, or impregnated with cleaning fluid. The cleaning sheet 40 may be in the form of either a roll of continuous sheet like the recording paper roll 12 or a cut sheet. When using the cleaning sheet 40 of a cut sheet type, it is preferable to connect it to the front end of the recording paper 11. The present embodiment uses the cleaning sheet 40 of a roll type.

In the cleaning process of the thermal head 22 using the cleaning sheet 40, the thermal head 22 is shifted to the pressing position by the head shift mechanism 24 in order to press the heating element array 22a against the cleaning sheet 40 in the same way as pressing it against the recording paper 11 in recording. The stains on the heating element array 22a are thus rubbed off by the cleaning sheet 40 under transportation.

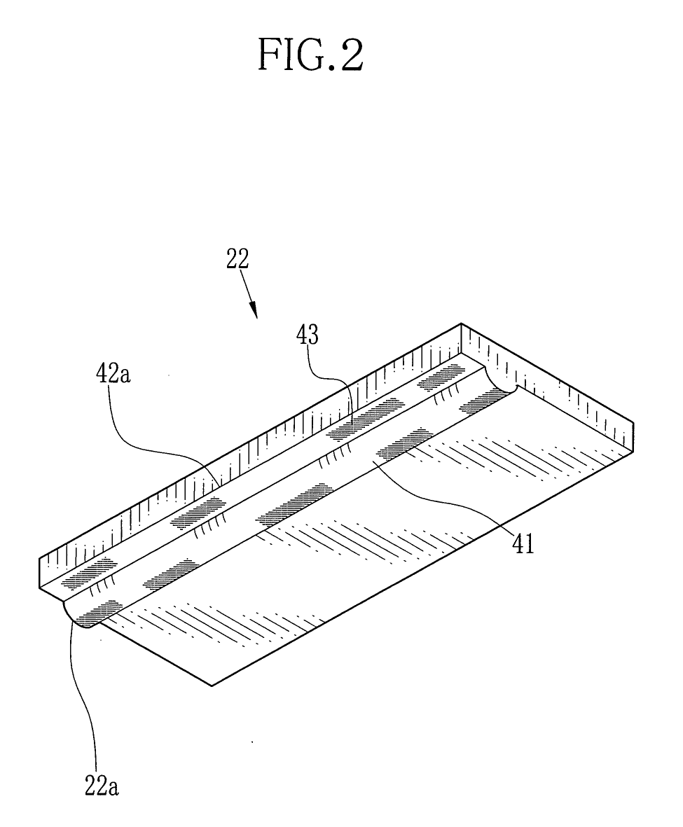

The stains such as paper powders on the thermal head 22 mainly adhere to the area from the center of the heating element array 22a to the downstream side of it in the rewinding direction shown in FIG. 1. As shown in detail in FIG. 2, there are two types of the stains adhering to two different areas on the thermal head 22: stains 41 to the heating element array 22a and stains 43 to a downstream area 42a on the substrate 42. Conventional cleaning methods have not been able to remove the stains 43. If the paper powder is accumulated on the downstream area 42a for a long period, the stains 43 scratch the surface of the recording paper 11 and causes glossy abrasions on recorded images.

In order to remove the stains 43 in the downstream area 42a of the substrate 42, the color thermal printer 10 is provided with a transport roller shift mechanism 51 for shifting the transport roller pair 16 in a direction approximately vertical to the regular transport path, as shown in FIG. 1. The system controller 21 shifts the transport roller pair 16 by controlling the transport roller shift mechanism 51 in the cleaning process of the thermal head 22 to use the cleaning sheet 40.

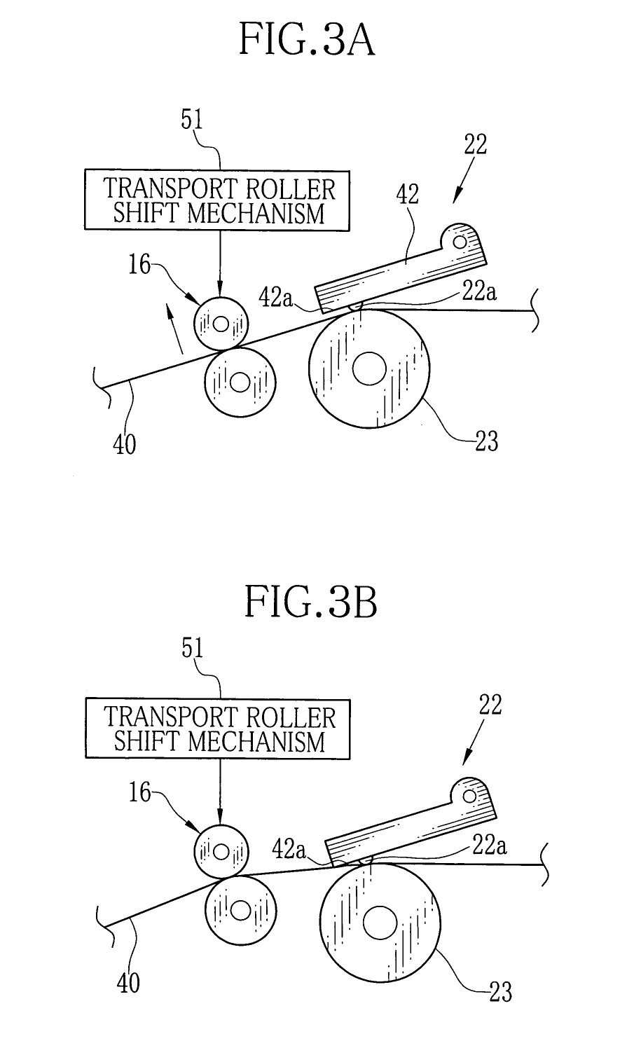

The transport roller shift mechanism 51 shifts the transport roller pair 16 between a regular transporting position shown in FIG. 3A and a transport path changing position vertically above the regular transport path shown in FIG. 3B. The transport path shifts relatively to the thermal head 22 when the transport roller pair 16 is shifted from the regular transporting position shown in FIG. 3A to the transport path changing position shown in FIG. 3B. Accordingly, the cleaning sheet 40 rubs the stains 43 off the downstream area 42a, when the transport roller pair 16 is shifted to the transport path changing position shown in FIG. 3B while transporting the cleaning sheet 40.

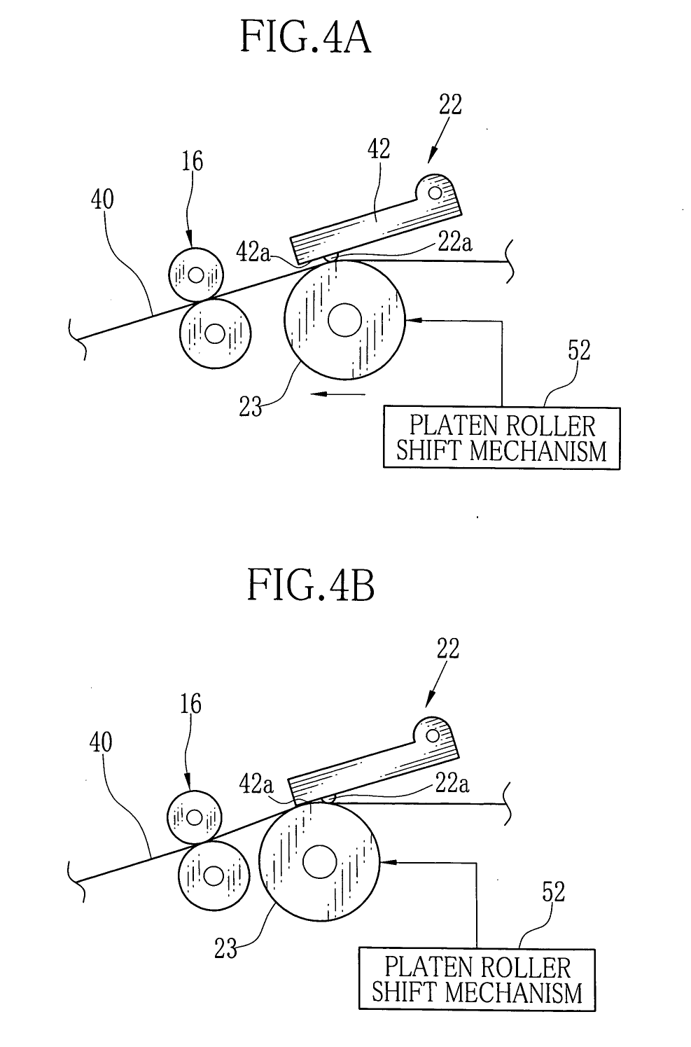

Note that the transport path is changed not only by shifting the transport roller pair 16 by the transport roller shift mechanism 51 but also, for example, by providing a platen roller shift mechanism 52 for shifting the platen roller 23 in approximately parallel direction to the transporting direction. In this case, the platen roller shift mechanism 52 shifts the platen roller 23 between a regular transporting position shown in FIG. 4A and a transport path changing position at the downstream side in the rewinding direction (shown by an arrow) as shown in FIG. 4B.

In response to the shift of the platen roller 23 from the regular transporting position to the transport path changing position, the transport path shifts relatively to the thermal head 22. The cleaning sheet 40 thus rubs the stains 43 off the downstream part 42a of the thermal head 22, when the platen roller 23 is shifted to the position shown in FIG. 4B while the cleaning sheet 40 is transported.

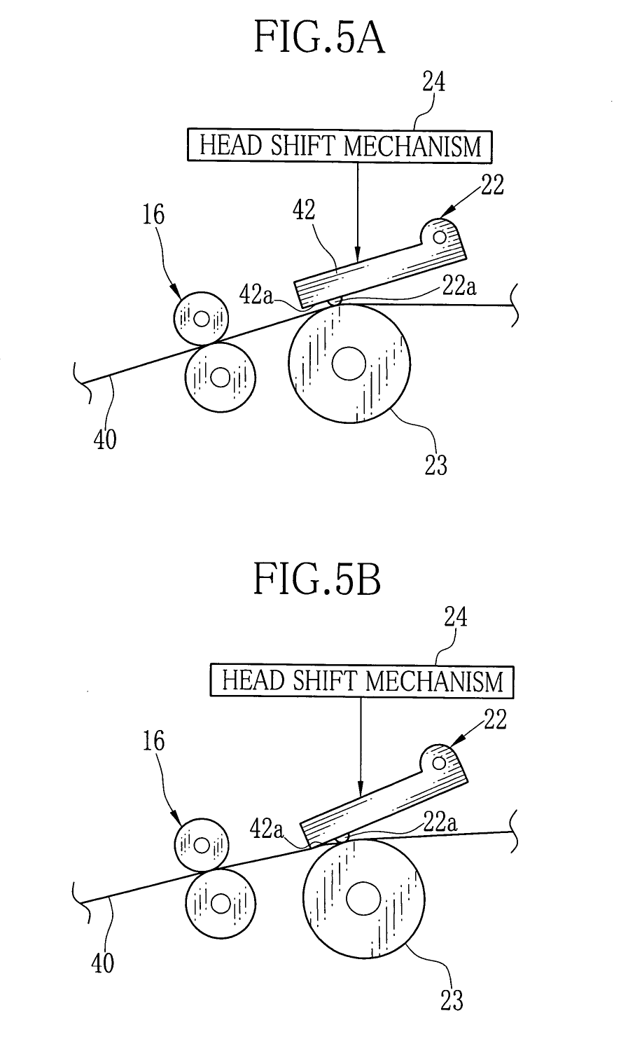

It is also possible to relatively shift the transport path to the thermal head 22 by shifting the thermal head 22 itself. In this case, a head shift mechanism 24 rotates the front part of the thermal head 22 (the part at the downstream side in the rewinding direction) to a transport path changing position shown in FIG. 5B, which is below a regular pressing position for image recording shown in FIG. 5A. In response to the shift of the thermal head 22, the platen roller 23 also shifts downward. Biased to the regular pressing position by a spring, the platen roller 23 is still able to nip the cleaning sheet 40 with the heating element array 22a even in the downward position.

When the thermal head 22 is shifted, the cleaning sheet 40 rubs the stains 43 off the downstream area 42a of the substrate 42. Note that it is also possible to provide another shift mechanism for shifting the thermal head 22 in addition to the head shift mechanism 24. In this case, the additional shift mechanism and the head shift mechanism 24 together rotate the thermal head 22 about the heating element array 22a, while the platen roller 23 is not shifted. The downstream area 42, the front part of the thermal head 22, thus shifts downward to come in contact with the surface of the cleaning sheet 40.

As stated above, the transport path of the cleaning sheet 40 is shifted relatively to the thermal head 22 by the shifts of the transportation roller path 16, the platen roller 23, or the thermal head 22. In response to those shifts, the guide mechanism (not shown) forming the transport path is also shifted.

Note that the transport roller pair 16, the platen roller 23, and the thermal head 22 are shifted by the transport roller shift mechanism 51, the platen roller shirt mechanism 52, and the head shift mechanism 24 respectively and each mechanism 51, 52 and 24 is driven by individual actuators. In addition, the transport roller pair 16 and the platen roller 23 are shifted not only in the directions shown in the above embodiment but also in any directions as long as they change the transport path such that the cleaning sheet 40 rubs the area downstream side of the heating element array 22a.

The color thermal printer 10 is provided with a detective sensor 53 between the recording paper roll 12 and the transport roller pair 16 for detecting deterioration in the quality of the images. The detective sensor 53 is, for example, a CCD line sensor, having a plurality of image pickup elements aligned in the main scanning direction to pick up the images in the recording areas of the recording paper 11 under transportation in the sub-scanning direction. The detective sensor 53 is connected to the system controller 21, to which it outputs the image data after picking up.

The system controller 21 is connected to a display 54 for displaying various setting screens and an operating section 55 comprising a plurality of buttons. Based on the image data from the detective sensor 53, the system controller 21 judges whether the recording areas carrying the images are deteriorated by streaks or uneven density caused by the stains of the thermal head 22.

When judging that the image is deteriorated, the system controller 21 displays a warning message on the display 54. The message is, for example, to inform that the thermal head 22 is stained or to urge to feed the cleaning sheet 40.

Next is an explanation of the cleaning operation of the thermal head 22 in the color thermal printer 10 having the above constitution. When the color thermal printer 10 is performing regular print operation, the system controller 21 displays the warning message on the display 54 if it judges that the image is deteriorated, based on the image data from the detective sensor 53.

When the warning message is displayed on the display 54, an operator stops the print operation by operating the operating section 55 and replaces the recording paper roll 12 with the roll of the cleaning sheet 40. The operator then operates the operating section 55 to instruct the system controller 21 to perform the cleaning operation of the thermal head 22. Note that it is also possible to perform the cleaning operation periodically instead of when the warning message is displayed on the display 54.

On gaining the instruction of the cleaning operation, the system controller 21 rotates the feed roller 13 and the transportation roller pair 16 by controlling a motor (not shown) to feed and transport the cleaning sheet 40. After the cleaning sheet passes the thermal head 22, the system controller 21 shifts the thermal head 22 to the pressing position by controlling the head shift mechanism 24.

The system controller 21 reciprocates the cleaning sheet 40 several times in the transporting direction and in the rewinding direction. The surface of the cleaning sheet 40 thus rubs against the heating element array 22a of the thermal head 22 rubbing the stains 41 off the heating element array 22a.

By controlling the transport roller shift mechanism 51, the system controller 21 then shifts the transport roller pair 16 from the regular transporting position shown in FIG. 3A to the transport path changing position shown in FIG. 3B. The transport path is thus shifted relatively to the thermal head 22. Subsequently, the system controller 21 reciprocates the cleaning sheet 40 several times in the transporting direction and in the rewinding direction rubbing the surface of the cleaning sheet 40 against the downstream area 42a of the substrate 42. Thus the stains 43 are rubbed off the downstream area 42a. Note that it is also possible to remove the stains 43 on the downstream area 42a by shifting either the platen roller 23 or thermal head 22 as described above.

Furthermore, it is also possible to remove the stains on the upstream side of the heating element array 22a by rubbing the surface of the cleaning sheet 40 against the upstream side of the heating element array 22a on the substrate 42 either by shifting the platen roller 23 in the direction opposite to the transport path changing position by the platen roller shift mechanism 52, or by pushing the thermal head 22 upward in the direction opposite to the transport path changing position by the head shift mechanism 24 or the additional shift mechanism.

After the thermal head 22 is cleaned, the system controller 21 rotates the feed roller 13 and the transport roller pair 16 by controlling the motor (not shown) to transport the cleaning sheet 40. A used part of the cleaning sheet is cut by the cutter 32 and discharged from the discharge opening 33, and then the cleaning process is finished. After the cleaning process, the roll of the cleaning sheet 40 is replaced with the recording paper roll 12.

Note that the present invention may be applied also to a color thermal printer using a recording paper of the cut sheet type instead of the continuous recording paper in the above embodiment. In this case, a cleaning sheet of the cut sheet type is used to clean the thermal head. In addition, the present invention is also applicable to other thermal printers having thermal heads such as thermal transfer printers, instead of the color direct thermal printer applied in the above embodiment.

Although the present invention has been described with respect to the preferred embodiments, the present invention is not to be limited to the above embodiments but, on the contrary, various modifications will be possible to those skilled in the art without departing from the scope of claims appended hereto.

1. A method for cleaning a thermal head in a thermal printer, said thermal printer recording images on a recording paper with said thermal head while said recording paper being transported in a transport path by a transport roller pair, said thermal head having a substrate with a heating element array formed thereon, said heating element array extending in a sub-scanning direction of said recording paper, said cleaning method comprising the steps of:
A. shifting said transport path from a recording position to a cleaning position;
B. nipping said cleaning sheet between said thermal head and a platen roller; and
C. removing stains adhering to said heating element array and the surrounding area by moving said cleaning sheet.

2. A cleaning method defined in claim 1, wherein said recording paper does not come in contact with said substrate in said recording position, and said cleaning sheet is capable of coming in contact with a part of said substrate in said cleaning position after passing said heating element array.

3. A cleaning method defined in claim 2, wherein said step A is performed by shifting said transport roller pair.

4. A cleaning method defined in claim 2, wherein said step A is performed by shifting said platen roller toward said transport roller pair.

5. A cleaning method defined in claim 2, wherein said step A is performed by increasing a tilt angle of said thermal head larger than that in recording, the front side of said thermal head is swingable about the rear side of said substrate, and said heating element array is disposed in said front side of said thermal head.

6. A thermal printer for recording images on a recording paper comprising:
a thermal head for thermally recording images on said recording paper, said thermal head having a substrate with a heating element array formed thereon, said heating element array extending in a sub-scanning direction of said recording paper;
a platen roller for supporting said recording paper when said heating element array pressing against said recording paper;
a transport roller pair for transporting said recording paper in a transport path while nipping said recording paper, in order for said recording paper to pass between said heating element array and said platen roller; and
a shift mechanism for shifting said transport path from a recording position to a cleaning position in order to clean said heating element array and the surrounding area by transporting a cleaning sheet in said transport path.

7. A thermal printer defined in claim 6, wherein said recording paper does not come in contact with said substrate in said recording position, and said cleaning sheet is capable of coming in contact with a part of said substrate in said cleaning position after passing said heating element array.

8. A thermal printer defined in claim 7, wherein said shift mechanism shifts said transport roller pair.

9. A thermal printer defined in claim 7, wherein said shift mechanism shifts said platen roller toward said transport roller pair.

10. A thermal printer defined in claim 7, wherein said shift mechanism increases a tilt angle of said thermal head larger than that in recording, the front side of said thermal head is swingable about the rear side of said substrate, and said heating element array is disposed in said front side of said thermal head.
